(19) United States
(12) Patent Application Publication
(10) Pub. No.: US 2025/0357866 A1
(43) Pub. Date: Nov. 20, 2025

(54) POWER CONVERSION CIRCUIT AND CONTROL METHOD THEREOF FOR DRIVING HIGH-SIDE TRANSISTOR AND LOW-SIDE TRANSISTOR BY USING CURRENT FLOWING THROUGH RESONANT CAPACITOR, VOLTAGE ACROSS RESONANT CAPACITOR, COMPENSATION SIGNAL, AND INPUT VOLTAGE

(71) Applicant: Richtek Technology Corporation, Zhubei City (TW)

(72) Inventors: Kuo-Chi LIU, Hsinchu City (TW); Ta-Yung YANG, Taoyuan City (TW); Yi-Min SHIU, Hsinchu City (TW); Tzu-Chen LIN, Zhubei City, Hsinchu County (TW)

(21) Appl. No.: 19/204,776

(22) Filed: May 12, 2025

Related U.S. Application Data
(60) Provisional application No. 63/647,125, filed on May 14, 2024.

(30) Foreign Application Priority Data
Jan. 15, 2025 (TW) 114101621

(51) Int. Cl. H02M 3/335; H02M 1/00; H02M 1/38; H02M 3/00

(52) U.S. Cl. CPC H02M 3/33569; H02M 1/0009; H02M 1/0058; H02M 1/385; H02M 3/01

(57) ABSTRACT

A power converter includes a transformer, a resonant capacitor, a high-side transistor, a low-side transistor, a rectification circuit, a feedback circuit, a detection circuit, and a control circuit. The transformer includes a primary coil coupled to a switch node and a secondary coil. The resonant capacitor is coupled to the primary coil. The high-side transistor provides an input voltage to the switch node, and the low-side transistor couples the switch node to the ground. The rectification circuit converts the energy of the secondary coil into an output voltage. The feedback circuit compares the output voltage with a reference voltage to generate a compensation signal. The detection circuit generates a current detection signal and a voltage detection signal. The control circuit drives the high-side transistor and the low-side transistor based on the current detection signal, the voltage detection signal, the compensation signal, and the input signal.

### CROSS REFERENCE TO RELATED APPLICATIONS

This application claims the benefit of U.S. Provisional Application No. 63/647,125, filed on May 14, 2024, the entirety of which is incorporated by reference herein.

This application claims priority of Taiwan Patent Application No. 114101621, filed on Jan. 15, 2025, the entirety of which is incorporated by reference herein.

### BACKGROUND OF THE INVENTION

### Field of the Invention

The disclosure is generally related to a power conversion circuit and a control method thereof, and more particularly it is related to a power conversion circuit and a control method thereof that drives the high-side transistor and the low-side transistor by using the current flowing through the resonant capacitor, the voltage across the resonant capacitor, a compensation signal, and an input voltage.

### Description of the Related Art

With the continuous advancements being made in portable electronic devices, the development of power conversion circuits, like most power products, is trending in the direction of high efficiency, high power density, high reliability, and low cost. A resonant power conversion circuit (including LLC resonant power conversion circuit, etc.) has the advantages of achieving zero-voltage switching (ZVS) on the primary side and zero-current switching (ZCS) of the rectification diode on the secondary side within the full load range, causing the duty cycles of the high-side and low-side transistors to both be 50% by frequency control. No output inductor is required, and low-voltage transistors can be used on the secondary side. This leads to cost reductions and efficiency improvements. The resonant power conversion circuit has been increasingly used for DC voltage conversion in recent years.

However, due to the circuit characteristics of the resonant power conversion circuit, a higher switching frequency must be used when the output voltage is low or the load is light, resulting in poor conversion efficiency of the resonant power conversion circuit. In order to meet the current market demand for a wide range of output voltages, high output power, and high conversion efficiency, it is necessary to further optimize the power conversion circuit to meet market demand.

### BRIEF SUMMARY OF THE INVENTION

The present invention proposes a power conversion circuit and a control method thereof, so that the LLC resonant power conversion circuit has a wider output voltage range and also achieves zero voltage switching to reduce switching power loss. In addition, the power conversion circuit and control method thereof proposed in the present invention can detect the voltage of the switch node and turn on the low-side transistor when the voltage is relatively low, which helps to further reduce power loss. Furthermore, the voltage across the resonant capacitor can be adjusted by adjusting the threshold voltage, thereby balancing the currents flowing through the rectification units to reduce the ripple of the output voltage. The lower ripple of the output voltage allows the use of a smaller output capacitor.

In an embodiment, a power conversion circuit comprises a transformer, a resonant capacitor, a high-side transistor, a low-side transistor, a rectification circuit, a feedback circuit, a detection circuit, and a control circuit. The transformer comprises a primary coil and a secondary coil, wherein the primary coil is coupled between a switch node and a resonant node. The resonant capacitor is coupled between the resonant node and a ground. The high-side transistor provides an input voltage to the switch node based on a high-side driving signal. The low-side transistor couples the switch node to the ground based on a low-side driving signal. The rectification circuit converts the energy of the secondary coil into an output voltage. The feedback circuit compares the output voltage with a reference voltage to generate a compensation signal. The detection circuit is coupled to the resonant node to generate a current detection signal and a voltage detection signal. The control circuit generates the high-side driving signal and the low-side driving signal based on the current detection signal, the voltage detection signal, the compensation signal, and the input voltage. When the high-side transistor is turned on and the current detection signal exceeds the compensation signal, the control circuit turns off the high-side transistor. When the voltage detection signal does not exceed a threshold voltage, the control circuit turns off the low-side transistor.

According to an embodiment of the present invention, the detection circuit detects a current flowing through the resonant capacitor to generate the current detection signal. The voltage detection signal is related to a voltage across the resonant capacitor.

According to an embodiment of the present invention, the control circuit comprises a first comparator. The first comparator compares the current detection signal and the compensation signal to generate an output signal. The control circuit turns off the high-side transistor based on the output signal.

According to an embodiment of the present invention, the control circuit comprises a second comparator. The second comparator compares the voltage detection signal and the threshold voltage to generate an output signal. The control signal turns off the low-side transistor based on the output signal, thereby reducing a ripple of the output voltage.

According to an embodiment of the present invention, the threshold voltage is determined based on half of the input voltage.

According to an embodiment of the present invention, the rectification circuit comprises an output capacitor, a first rectification unit, and a second rectification unit. The first rectification unit regulates the energy of the secondary coil to generate a first current. The second rectification unit regulates the energy of the secondary coil to generate a second current. The first current and the second current are configured to charge the output capacitor to generate the output voltage. A direction of the first current is to the same as a direction of the second current.

According to an embodiment of the present invention, the voltage detection signal is close to the threshold voltage. When the voltage detection signal is close to half of the input voltage, magnitude of the first current is close to magnitude of the second current, thereby reducing a ripple of the output voltage.

According to an embodiment of the present invention, the control circuit comprises a valley-voltage detection circuit. The valley-voltage detection circuit is configured to detect a voltage across the low-side transistor at a relatively low point to generate a valley signal. The control circuit turns on the low-side transistor based on the valley signal, so as to reduce switching power loss of the low-side transistor.

According to an embodiment of the present invention, when the low-side transistor is turned off and a dead time has passed, the high-side transistor is turned on to achieve zero voltage switching.

According to an embodiment of the present invention, when the high-side transistor is turned off and a dead time has passed, the low-side transistor is turned on to achieve zero voltage switching.

According to an embodiment of the present invention, the detection circuit comprises a resistor and a capacitor. The resistor and the capacitor are connected in series between the resonant node and the ground. A voltage across the resistor is the current detection signal.

According to an embodiment of the present invention, the detection circuit further comprises an integrator. The integrator integrates the current detection signal to generate the voltage detection signal.

According to an embodiment of the present invention, the detection circuit comprises a detection resistor. The detection resistor is coupled between the resonant capacitor and the ground. A voltage across the detection resistor is the current detection signal.

According to an embodiment of the present invention, the detection circuit comprises a capacitance voltage-dividing circuit. The capacitance voltage-dividing circuit is coupled to both terminals of the resonant capacitor. The capacitance voltage-dividing circuit is configured to divide a voltage across the resonant capacitor to generate the voltage detection signal.

In another embodiment, a control method adapted to control a power conversion circuit is provided. The power conversion circuit comprises a resonant capacitor between a resonant node and a ground, a transformer comprising a primary coil and a secondary coil, a high-side transistor providing an input voltage to a switch node, a low-side transistor coupling the switch node to the ground, and a rectification circuit converting energy of the secondary coil into an output voltage. The primary coil is coupled between the switch node and the resonant node. the control method comprises the following steps. The output voltage is compared with a reference voltage to generate a compensation signal. A current detection signal is generated based on a current flowing through the resonant capacitor. A voltage detection signal related to a voltage across the resonant capacitor is generated. The high-side transistor and the low-side transistor are driven based on the current detection signal, the voltage detection signal, the compensation signal, and the input voltage. When the high-side transistor is turned on and the current detection signal exceeds the compensation signal, the high-side transistor is turned off. When the voltage detection signal does not exceed a threshold, the low-side transistor is turned off.

According to an embodiment of the present invention, the control method further comprises the following steps. A voltage across the low-side transistor is detected. When the voltage across the low-side transistor is a valley voltage, the low-side transistor is turned on, thereby reducing switching power loss of the low-side transistor.

According to an embodiment of the present invention, when the low-side transistor is turned off and a dead time has passed, the high-side transistor is turned on to achieve zero voltage switching.

According to an embodiment of the present invention, when the high-side transistor is turned off and a dead time has passed, the low-side transistor is turned on to achieve zero voltage switching.

According to an embodiment of the present invention, the threshold voltage is determined based on half of the input voltage.

According to an embodiment of the present invention, the rectification circuit comprises an output capacitor, a first rectification unit generating a first current, and a second rectification unit generating a second current. The first current and the second current charge the output capacitor to generate the output voltage. The voltage detection signal is close to the threshold voltage. When the voltage detection signal is close to half of the input voltage, magnitude of the first current is close to magnitude of the second current, so as to reduce a ripple of the output voltage.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic diagram showing a power conversion circuit in accordance with an embodiment of the present invention;

FIG. 2 is a schematic diagram showing a detection circuit in accordance with an embodiment of the present invention;

FIG. 3 is a schematic diagram showing a control circuit in accordance with an embodiment of the present invention;

FIG. 4 is a waveform diagram showing a power conversion circuit in accordance with an embodiment of the present invention;

FIG. 5 is a waveform diagram showing a power conversion circuit in accordance with another embodiment of the present invention;

FIG. 6 is a waveform diagram showing a power conversion circuit in accordance with another embodiment of the present invention;

FIG. 7 is a schematic diagram showing a control circuit in accordance with another embodiment of the present invention;

FIG. 8 is a waveform diagram showing a power conversion circuit in accordance with an embodiment of the present invention;

FIG. 9 is a waveform diagram showing a power conversion circuit in accordance with another embodiment of the present invention;

FIG. 10 is a waveform diagram showing a power conversion circuit in accordance with another embodiment of the present invention;

FIG. 11 is a schematic diagram showing a control circuit in accordance with another embodiment of the present invention;

FIG. 12 is a waveform diagram showing the control circuit of FIG. 11 in accordance with an embodiment of the present invention; and

FIG. 13 is a flow chart showing a control method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

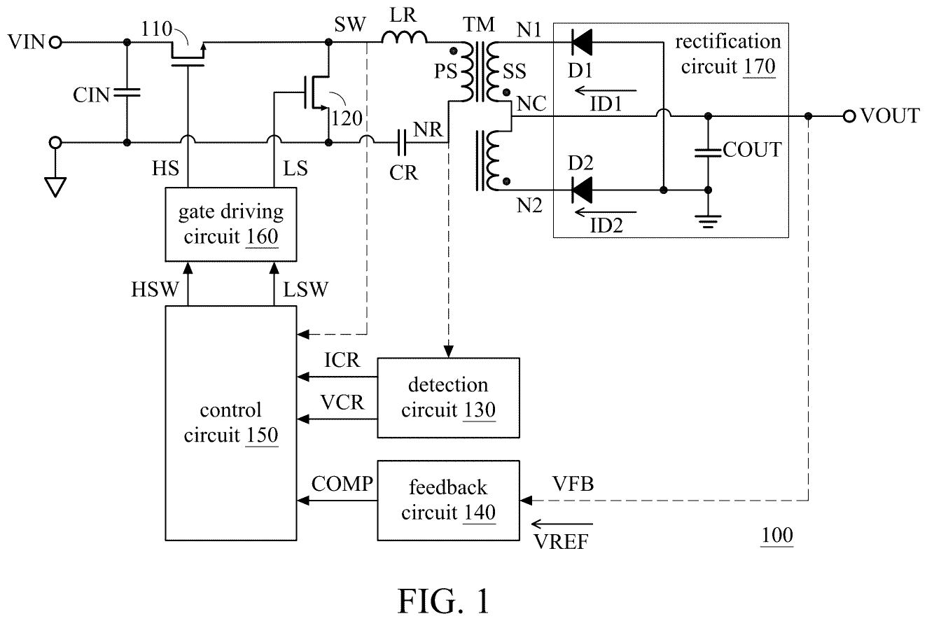

FIG. 1 is a schematic diagram showing a power conversion circuit in accordance with an embodiment of the present invention. As shown in FIG. 1, the power conversion circuit 100 is configured to convert an input voltage VIN into an output voltage VOUT, and includes a transformer TM, a resonant inductor LR, a resonant capacitor CR, an input capacitor CIN, a high-side transistor 110, a low-side transistor 120, a detection circuit 130, a feedback circuit 140, a control circuit 150, and a gate driving circuit 160.

The transformer TM includes a primary coil PS and a secondary coil SS, where the primary coil PS is coupled to a resonant node NR. The resonant inductor LR is coupled between the switch node SW and the primary coil PS, and the resonant capacitor CR is coupled between the resonant node NR and the ground. According to an embodiment of the present invention, the resonant inductor LR can be replaced by the leakage inductance of the primary coil PS of the transformer TM. In other words, the primary coil PS may be coupled between the switch node SW and the resonant node NR.

As shown in FIG. 1, the input capacitor CIN is coupled between the input voltage VIN and the ground. The high-side driving signal HS turns on and off the high-side transistor 110 to provide the input voltage VIN to the switch node SW. The low-side driving signal LS drives the low-side transistor 120 to be turned on and off, and couples the switch node SW to the ground. According to some embodiments of the present invention, the high-side transistor 110 and the low-side transistor 120 form a half-bridge circuit to drive the primary coil PS and the resonant capacitor CR.

The detection circuit 130 is coupled to the resonant node NR to generate a current detection signal ICR and a voltage detection signal VCR. According to some embodiments of the present invention, the current detection signal ICR is configured to indicate the current flowing through the resonant capacitor CR, and the voltage detection signal VCR is configured to indicate the voltage across the resonant capacitor CR. According to an embodiment of the present invention, the detection circuit 130 may include a detection resistor (not shown in FIG. 1) coupled between the resonant capacitor CR and the ground, where the voltage across the detection resistor is the current detection signal ICR. According to another embodiment of the present invention, a capacitance voltage-dividing circuit formed by a first detection capacitor and a second detection capacitor (not shown in FIG. 1) may be coupled between the resonant capacitor CR and the ground to divide the voltage of the resonant node NR to generate a voltage detection signal VCR.

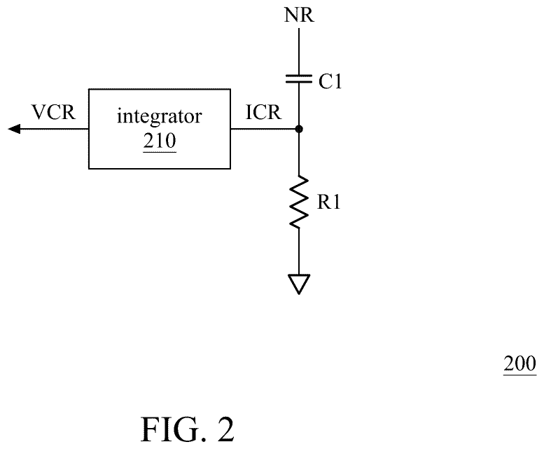

FIG. 2 is a schematic diagram showing a detection circuit in accordance with an embodiment of the present invention. As shown in FIG. 2, the detection circuit 200 includes a first capacitor C1, a first resistor R1, and an integrator 210. The first capacitor C1 and the first resistor R1 are connected in series between the resonant node NR and the ground shown in FIG. 1, and the voltage across the first resistor R1 is the current detection signal ICR. The integrator 210 integrates the current detection signal ICR to generate a voltage detection signal VCR, where the voltage detection signal VCR corresponds to the voltage of the resonant node NR. According to some embodiments of the present invention, the detection circuit 200 corresponds to the detection circuit 130 in FIG. 1.

Returning to FIG. 1, the feedback circuit 140 is configured to generate a compensation signal COMP based on the feedback voltage VFB and the reference voltage VREF. According to some embodiments of the present invention, the feedback voltage VFB is proportional to the output voltage VOUT. According to some embodiments of the present invention, the feedback circuit 140 may include an error amplifier, where the positive terminal of the error amplifier receives the reference voltage VREF, and the negative terminal receives the feedback voltage VFB. The feedback circuit 140 compares the feedback voltage VFB with the reference voltage VREF to generate a compensation signal COMP. It is illustrated that the compensation signal COMP is generated by utilizing the feedback voltage VFB herein, but the present invention is not intended to be limited thereto. According to other embodiments of the present invention, the feedback circuit 140 may also compare the output voltage VOUT with the reference voltage VREF to generate the compensation signal COMP.

According to some embodiments of the present invention, the feedback circuit 140 generates a compensation signal COMP using the difference between the feedback voltage VFB and the reference voltage VREF, so that the output voltage VOUT reaches the target value when the feedback voltage VFB is equal to the reference voltage VREF. According to an embodiment of the present invention, when the feedback voltage VFB exceeds the reference voltage VREF, the feedback circuit 140 reduces the compensation signal COMP. According to another embodiment of the present invention, when the reference voltage VREF exceeds the feedback voltage VFB, the feedback voltage increases the compensation signal COMP. According to an embodiment of the present invention, the feedback circuit 140 may include a voltage divider for dividing the output voltage VOUT to generate the feedback voltage VFB.

The control circuit 150 generates an high-side gate-driving signal HSW and a low-side gate-driving signal LSW based on the current detection signal ICR, the voltage detection signal VCR, the compensation signal COMP, and the voltage of the switch node SW. The gate driving circuit 160 generates a high-side driving signal HS based on the high-side gate-driving signal HSW, and generates a low-side driving signal LS based on the low-side gate-driving signal LSW.

As shown in FIG. 1, the power conversion circuit 100 further includes a rectification circuit 170. The rectification circuit 170 includes a first rectification unit D1, a second rectification unit D2, and an output capacitor COUT. The first rectification unit D1 is coupled between a first node N1 of the secondary coil SS and the ground. The second rectification unit D2 is coupled between the second node N2 of the secondary coil SS and the ground. The output capacitor COUT is coupled between a middle node NC of the secondary coil SS and the ground, and an output voltage VOUT is generated at the middle node NC.

According to some embodiments of the present invention, the first rectification unit D1 and the second rectification unit D2 rectify the energy of the secondary winding SS into the first current ID1 and the second current ID2 respectively and provide them to the output capacitor COUT, thereby generating the output voltage VOUT. According to some embodiments of the present invention, the power conversion circuit 100 may be an LLC resonant power conversion circuit.

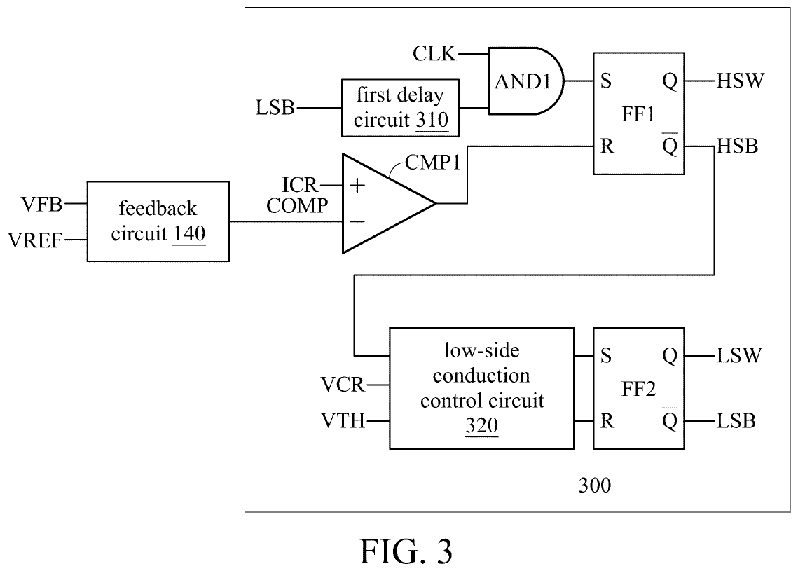

FIG. 3 is a schematic diagram showing a control circuit in accordance with an embodiment of the present invention. As shown in FIG. 3, the control circuit 300 includes a first delay circuit 310, a first AND gate AND1, a first flip-flop FF1, a low-side conduction control circuit 320, a second flip-flop FF2, and a first comparator CMPL.

The first delay circuit 310 delays the inverted low-side driving signal LSB, so that the first flip-flop FF1 enables the high-side gate-driving signal HSW based on the output signal of the first delay circuit 310 and the clock signal CLK. When the compensation signal COMP generated by the feedback circuit 140 of FIG. 1 does not exceed the current detection signal ICR, the first comparator CMP1 resets the first flip-flop FF1 to disable the high-side gate-driving signal HSW. The low-side conduction control circuit 320 sets or resets the second flip-flop FF2 based on the inverted high-side gate-driving signal HSB (an inverse of the high-side gate-driving signal HSW), the voltage detection signal VCR, and the threshold voltage VTH, thereby generating the low-side gate-driving signal LSW and the inverted low-side gate-driving signal LSB.

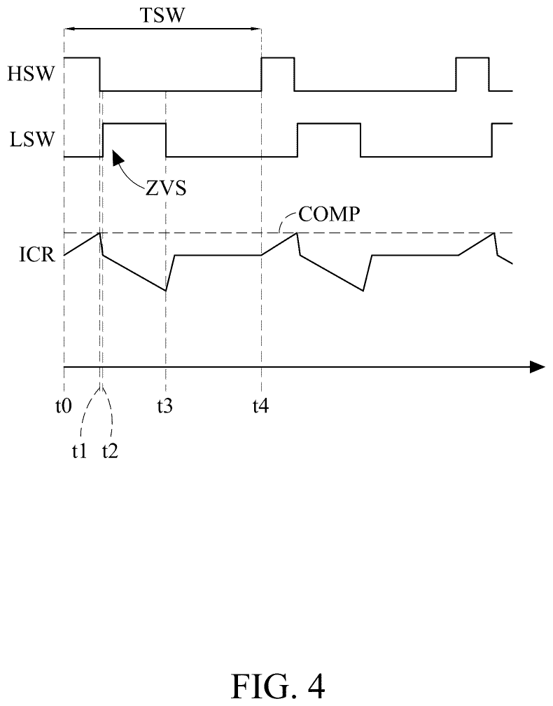

FIG. 4 is a waveform diagram showing a power conversion circuit in accordance with an embodiment of the present invention. The power conversion circuit 100 of FIG. 1 and the control circuit 300 of FIG. 3 will be accompanied with the waveform diagram of FIG. 4 in the following paragraphs for detailed description. As shown in FIG. 4, in a switching cycle TSW, the high-side gate-driving signal HSW is first enabled at an initial time point t0. At the first time point t1, the current detection signal ICR exceeds the compensation signal COMP and the high-side gate-driving signal HSW is disabled. After the dead time, the low-side gate-driving signal LSW is enabled at the second time point t2. According to an embodiment of the present invention, when the low-side transistor 120 is turned on at the second time point t2, zero-voltage switching (ZVS) can be achieved to reduce switching power loss. Then, the low-side gate-driving signal LSW is disabled at the third time point t3, and the current detection signal ICR is zero from the third time point t3 to the fourth time point t4, which means that the current flowing through the resonant capacitor CR is zero.

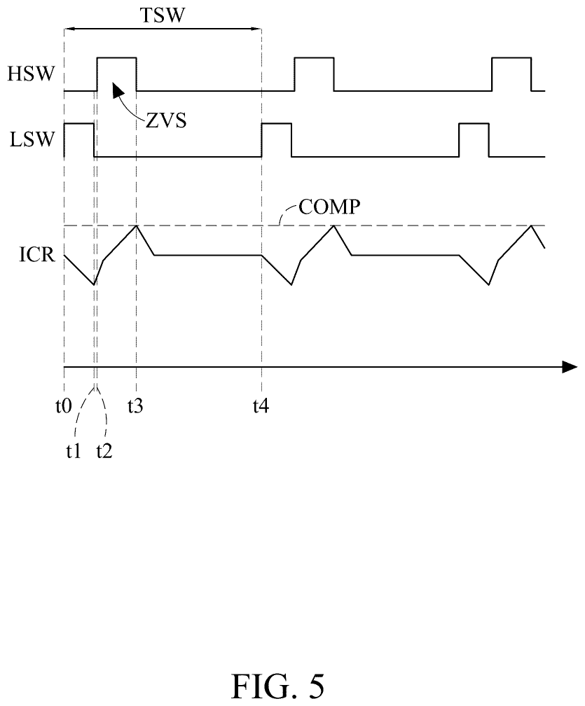

FIG. 5 is a waveform diagram showing a power conversion circuit in accordance with another embodiment of the present invention. As shown in FIG. 5, the low-side gate-driving signal LSW is enabled at the initial time point t0, and after the low-side gate-driving signal LSW is disabled (first time point t1) and the dead time has passed, the high-side gate-driving signal HSW is enabled (second time point t2). According to an embodiment of the present invention, when the high-side gate-driving signal HSW is enabled at the second time point t2, the high-side transistor 110 can achieve zero voltage switching.

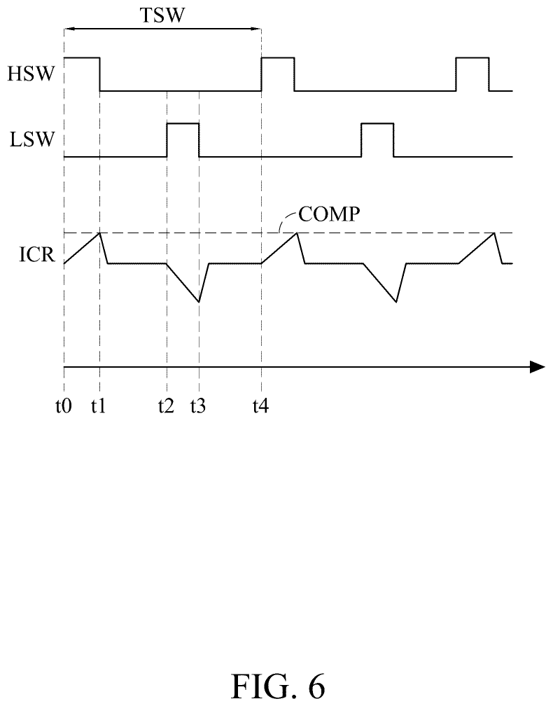

FIG. 6 is a waveform diagram showing a power conversion circuit in accordance with another embodiment of the present invention. As shown in FIG. 6, the high-side gate-driving signal HSW is enabled at the initial time point t0 and disabled at the first time point t1, and the low-side gate-driving signal LSW is enabled at half of the switching period TSW (i.e., the second time point t2) and disabled at the third time point t3. According to an embodiment of the present invention, the conduction periods of the high-side gate-driving signal HSW and the low-side gate-driving signal LSW in FIG. 6 are both less than 50%.

In FIG. 4-6, when the high-side gate-driving signal HSW is enabled, the current detection signal ICR increases; and when the current detection signal ICR exceeds the compensation signal COMP, the high-side gate-driving signal HSW is disabled.

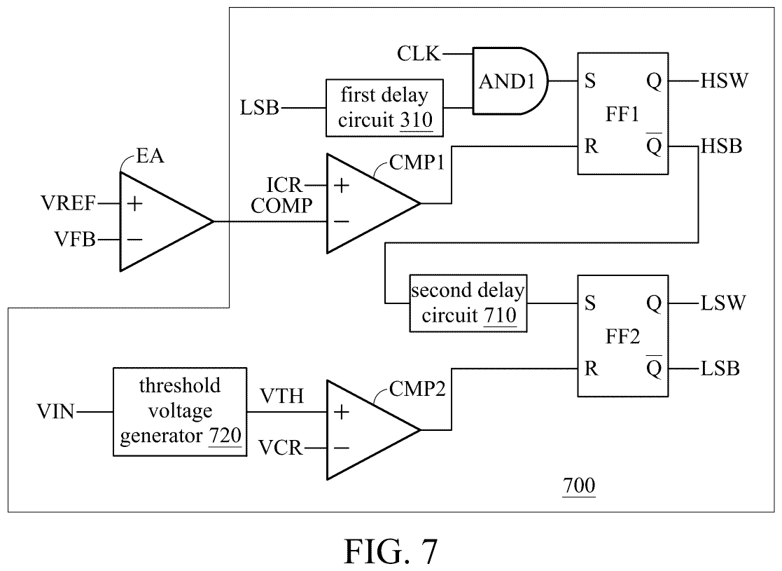

FIG. 7 is a schematic diagram showing a control circuit in accordance with another embodiment of the present invention. Comparing the control circuit 700 of FIG. 7 with the control circuit 300 of FIG. 3, the low-side conduction control circuit 320 of FIG. 3 is replaced by a second delay circuit 710, a threshold voltage generator 720, and a second comparator CMP2, and the feedback circuit 140 of FIG. 3 is replaced by an error amplifier EA. In other words, the feedback circuit 140 may include an error amplifier EA. According to an embodiment of the present invention, the control circuit 700 is configured to implement the waveform diagram of FIG. 4. In other words, the control circuit 700 turns on the high-side transistor 110 first, and then turns on the low-side transistor 120.

First, the enabled inverted low-side gate-driving signal LSB (i.e., the low-side gate-driving signal LSW is in a disabled state) and the clock signal CLK set the first flip-flop FF1 through the first delay circuit 310 and the first AND gate AND1, thereby enabling the high-side gate-driving signal HSW. According to an embodiment of the present invention, the delay time of the first delay circuit 310 is configured to determine the dead time from that the low-side transistor 120 is turned off to that the high-side transistor 110 is turned on.

The error amplifier EA generates a compensation signal COMP based on the difference between the feedback voltage VFB and the reference voltage VREF. When the current detection signal ICR exceeds the compensation signal COMP, the output signal of the first comparator CMP1 resets the first flip-flop FF1 to disable the high-side gate-driving signal HSW.

The second delay circuit 710 delays the inverted high-side gate-driving signal HSB being at the enabled state to set the second flip-flop FF2, so as to enable the low-side gate-driving signal LSW. According to an embodiment of the present invention, the delay time of the second delay circuit 710 is configured to determine the dead time from that the high-side transistor 110 is turned off to that the low-side transistor 120 is turned on. The threshold voltage generator 720 generates a threshold voltage VTH based on the input voltage VIN. The second comparator CMP2 compares the voltage detection signal VCR with the threshold voltage VTH to reset the second flip-flop FF2, so as to disable the low-side gate-driving signal LSW.

According to one embodiment of the present invention, when the voltage detection signal VCR does not exceed the threshold voltage VTH, the output signal of the second comparator CMP2 resets the second flip-flop FF2, thereby turning off the low-side transistor 120. The relationship between the threshold voltage VTH and the input voltage VIN will be described in detail in the following paragraphs.

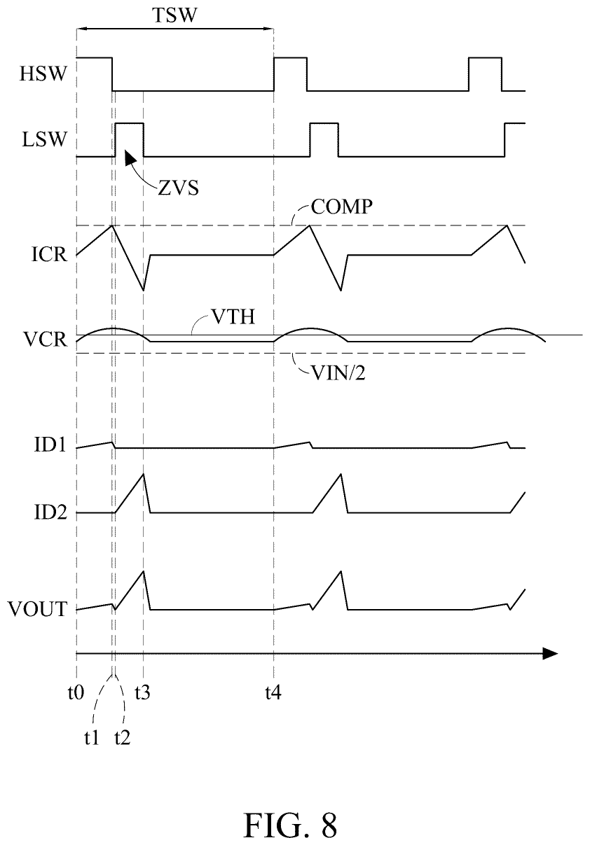

FIG. 8 is a waveform diagram showing a power conversion circuit in accordance with an embodiment of the present invention. The power conversion circuit 100 of FIG. 1 and the control circuit 700 of FIG. 7 will be described in detail in the following paragraphs. As shown in FIG. 8, the threshold voltage VTH exceeds half of the input voltage VIN, and the second current ID2 exceeds the first current ID1, so that the ripple of the output voltage VOUT is larger.

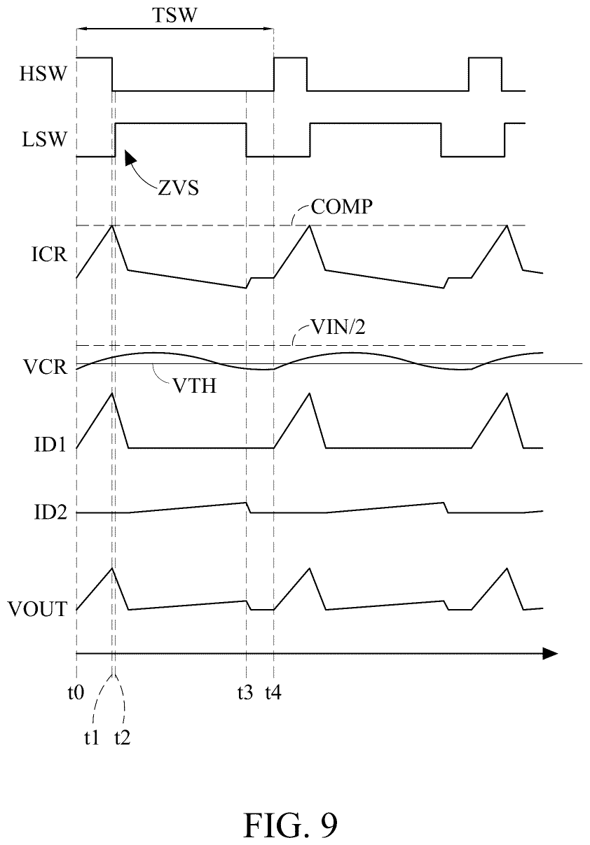

FIG. 9 is a waveform diagram showing a power conversion circuit in accordance with another embodiment of the present invention. As shown in FIG. 9, the threshold voltage VTH is less than half of the input voltage VIN, and the first current ID1 exceeds the second current ID2, so that the ripple of the output voltage VOUT is larger.

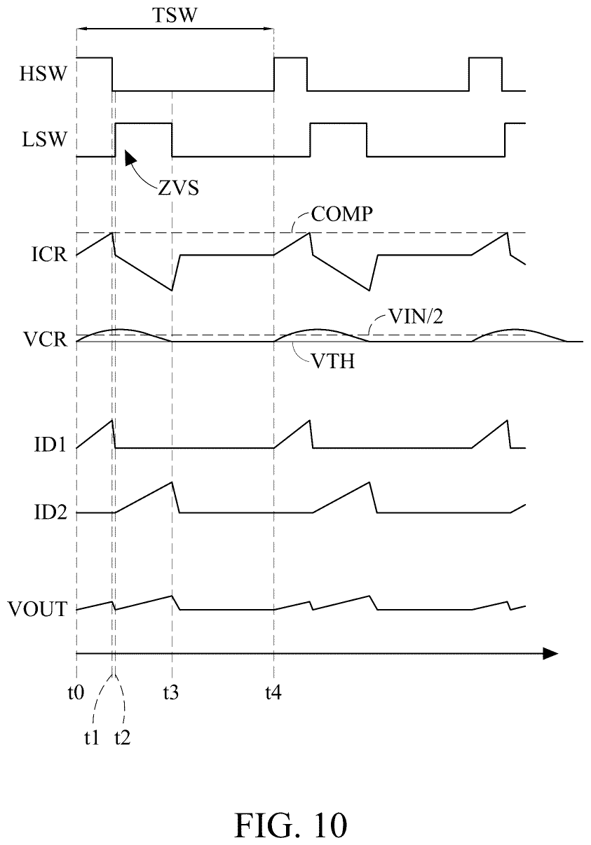

FIG. 10 is a waveform diagram showing a power conversion circuit in accordance with another embodiment of the present invention. As shown in FIG. 10, the threshold voltage VTH is close to, and slightly less than, half of the input voltage VIN, and the first current ID1 is similar to the second current ID2, so that the ripple of the output voltage VOUT is smaller.

Comparing FIG. 8-10, it would be understood that the voltage detection signal VCR can be controlled to approximately half of the input voltage VIN by adjusting the threshold voltage VTH to approximately half of the input voltage VIN. According to some embodiments of the present invention, the threshold voltage VTH is configured to control the conduction time of the low-side transistor 120, thereby controlling the voltage detection signal VCR to be close to half of the input voltage VIN for generating a low-ripple output voltage VOUT.

According to some embodiments of the present invention, when the ripple of the output voltage VOUT is smaller, the capacitance value of the output capacitor COUT can be reduced. According to some embodiments of the present invention, the power conversion circuit 100 of FIG. 1 may generate a high-side gate-driving signal HSW and a low-side gate-driving signal LSW based on a current detection signal ICR, a voltage detection signal VCR, a compensation signal COMP, a voltage of a switch node SW, and an input voltage VIN for driving the high-side transistor 110 and the low-side transistor 120. According to some embodiments of the present invention, the control circuit 300 of FIG. 3 and the control circuit 700 of FIG. 7 may achieve zero voltage switching to reduce power loss and generate a low ripple output voltage VOUT for reducing the capacitance value of the output capacitor COUT.

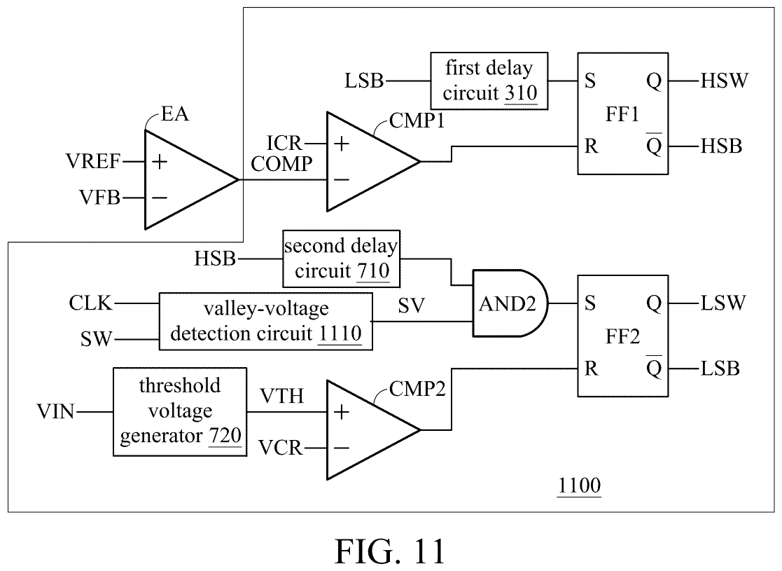

FIG. 11 is a schematic diagram showing a control circuit in accordance with another embodiment of the present invention. Comparing the control circuit 1100 of FIG. 11 with the control circuit 700 of FIG. 7, the control circuit 1100 removes the first AND gate AND1 of FIG. 7 and further includes a valley-voltage detection circuit 1110 and a second AND gate AND2. According to one embodiment of the present invention, the control circuit 1100 is configured to implement the waveform diagram of FIG. 5. In other words, the control circuit 1100 turns on the low-side transistor 120 first, and then turns on the high-side transistor 110.

The second delay circuit 710 delays the inverted high-side gate-driving signal HSB to generate a delay signal. The second AND gate AND2 performs a logic AND operation on the delay signal and the valley signal SV to set a second flip-flop FF2, thereby enabling the low-side gate-driving signal LSW. According to an embodiment of the present invention, the delay time of the second delay circuit 710 is configured to determine the dead time from that the high-side transistor 110 is turned off to that the low-side transistor 120 is turned on.

The valley voltage detection circuit 1110 detects that the voltage of the switch node SW is at the valley voltage based on the clock signal CLK and then enables the valley signal SV. According to an embodiment of the present invention, when the voltage of the switch node SW is at a relatively low point, the valley voltage detection circuit 1110 enables the valley signal SV.

When the voltage detection signal VCR drops to a value not exceeding the threshold voltage VTH, the output signal of the second comparator CMP2 resets the second flip-flop FF2 to disable the low-side gate drive signal LSW, thereby turning off the low-side transistor 120. According to some embodiments of the present invention, the threshold voltage VTH is approximately half of the input voltage VIN.

When the low-side transistor 120 is not turned on, the low-side gate-driving signal LSW is disabled, and the enabled inverted low-side gate-driving signal LSB is set the first flip-flop FF1 via the first delay circuit 310, thereby enabling the high-side gate-driving signal HSW to turn on the high-side transistor 110. When the current detection signal ICR exceeds the compensation signal COMP, the output signal of the first comparator CMP1 resets the first flip-flop FF1 to disable the high-side gate-driving signal HSW, thereby turning off the high-side transistor 110.

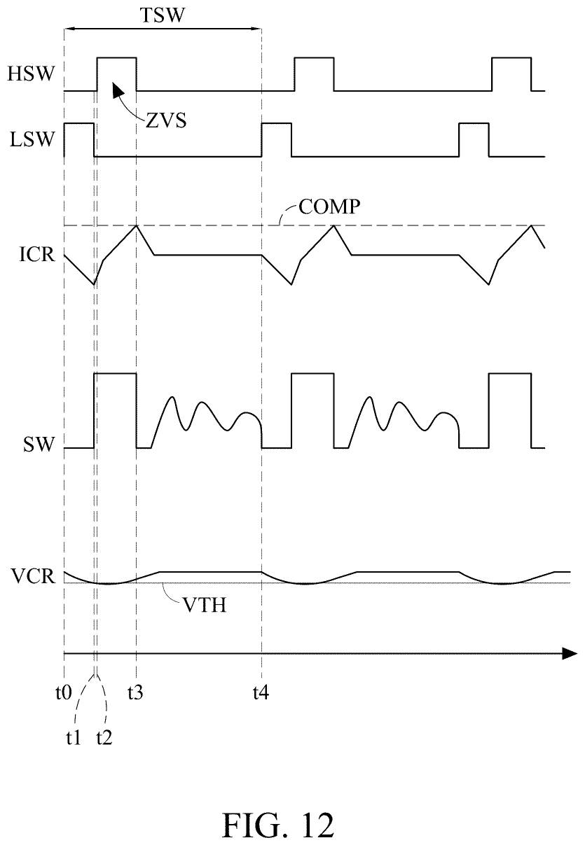

FIG. 12 is a waveform diagram showing the control circuit of FIG. 11 in accordance with an embodiment of the present invention. As shown in FIG. 12, at the start time point t0, the low-side gate-driving signal LSW is enabled to turn on the low-side transistor 120. At the first time point t1, the voltage detection signal VCR does not exceed the threshold voltage VTH and the low-side transistor 120 is turned off, and the voltage of the switch node SW rises. At the second time point t2, the high-side gate-driving signal HSW is enabled to turn on the high-side transistor 110. According to an embodiment of the present invention, the current originally flowing through the low-side transistor 120 turns on the parasitic diode of the high-side transistor 110 and causes the voltage of the switch node SW to rise at the first time point t1, so that the high-side transistor 110 turns on at the second time point t2 to achieve zero voltage switching.

After the high-side transistor 110 is turned on, the current detection signal ICR continues to rise, and at the third time point t3, the current detection signal ICR exceeds the compensation signal COMP and disables the high-side gate-driving signal HSW. When the low-side gate-driving signal LSW is enabled again at the fourth time point t4, the valley-voltage detection circuit 1110 enables the low-side gate-driving signal LSW to turn on the low-side transistor 120 once the voltage of the switch node SW at a relatively low point is detected, thereby reducing the power loss when the low-side transistor 120 is turned on.

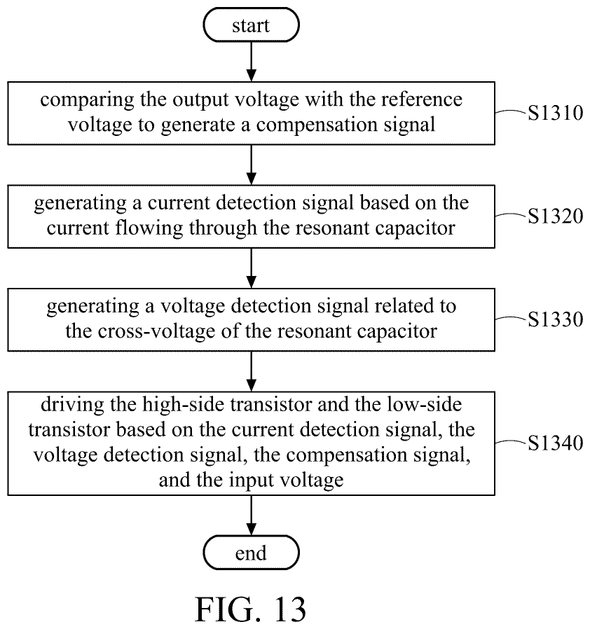

FIG. 13 is a flow chart showing a control method in accordance with an embodiment of the present invention. The following description of the control method 1300 will be described in detail with reference with the power conversion circuit 100 of FIG. 1.

First, the output voltage VOUT is compared with the reference voltage VREF to generate a compensation signal COMP by the feedback circuit 140 (Step S1310). A current detection signal ICR is generated based on the current flowing through the resonant capacitor CR by the detection circuit 130 (Step S1320). A voltage detection signal VCR related to the cross-voltage of the resonant capacitor CR is generated by the detection circuit 130 (Step S1330). The high-side transistor 110 and the low-side transistor 120 are driven based on the current detection signal ICR, the voltage detection signal VCR, the compensation signal COMP and the input voltage VIN by the control circuit 150 (Step S1340).

According to one embodiment of the present invention, when the high-side transistor 110 is turned on and the current detection signal ICR exceeds the compensation signal COMP, the high-side transistor 110 is turned off. According to another embodiment of the present invention, when the voltage detection signal VCR does not exceed the threshold voltage VTH, the low-side transistor 120 is turned off. According to an embodiment of the present invention, the threshold voltage VTH is determined based on half of the input voltage VIN. According to an embodiment of the present invention, the valley-voltage detection circuit 1110 of FIG. 11 detects whether the voltage of the switch node SW is at a relatively low point to determine the timing of turning off the low-side transistor 120. In other words, Step S1340 can also drive the high-side transistor 110 and the low-side transistor 120 based on the current detection signal ICR, the voltage detection signal VCR, the compensation signal COMP, the input voltage VIN, and the voltage of the switch node SW.

The present invention proposes a power conversion circuit and a control method thereof, so that the LLC resonant power conversion circuit has a wider output voltage range and also achieves zero voltage switching to reduce switching power loss. In addition, the power conversion circuit and control method thereof proposed in the present invention can detect the voltage of the switch node and turn on the low-side transistor when the voltage is relatively low, which helps to further reduce power loss. Furthermore, the voltage across the resonant capacitor can be adjusted by adjusting the threshold voltage, thereby balancing the currents flowing through the rectification units to reduce the ripple of the output voltage. The lower ripple of the output voltage allows the use of a smaller output capacitor.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A power conversion circuit, comprising:
a transformer, comprising a primary coil and a secondary coil, wherein the primary coil is coupled between a switch node and a resonant node;
a resonant capacitor, coupled between the resonant node and a ground;
a high-side transistor, providing an input voltage to the switch node based on a high-side driving signal;
a low-side transistor, coupling the switch node to the ground based on a low-side driving signal;
a rectification circuit, converting energy of the secondary coil into an output voltage;
a feedback circuit, comparing the output voltage with a reference voltage to generate a compensation signal;
a detection circuit, coupled to the resonant node to generate a current detection signal and a voltage detection signal; and
a control circuit, generating the high-side driving signal and the low-side driving signal based on the current detection signal, the voltage detection signal, the compensation signal, and the input voltage;
wherein when the high-side transistor is turned on and the current detection signal exceeds the compensation signal, the control circuit turns off the high-side transistor;
wherein when the voltage detection signal does not exceed a threshold voltage, the control circuit turns off the low-side transistor.

2. The power conversion circuit as claimed in claim 1, wherein the detection circuit detects a current flowing through the resonant capacitor to generate the current detection signal;
wherein the voltage detection signal is related to a voltage across the resonant capacitor.

3. The power conversion circuit as claimed in claim 1, wherein the control circuit comprises:
a first comparator, comparing the current detection signal and the compensation signal to generate an output signal;
wherein the control circuit turns off the high-side transistor based on the output signal.

4. The power conversion circuit as claimed in claim 1, wherein the control circuit comprises:
a second comparator, comparing the voltage detection signal and the threshold voltage to generate an output signal;
wherein the control signal turns off the low-side transistor based on the output signal, thereby reducing a ripple of the output voltage.

5. The power conversion circuit as claimed in claim 4, wherein the threshold voltage is determined based on half of the input voltage.

6. The power conversion circuit as claimed in claim 5, wherein the rectification circuit comprises:
an output capacitor;
a first rectification unit, regulating the energy of the secondary coil to generate a first current; and
a second rectification unit, regulating the energy of the secondary coil to generate a second current;
wherein the first current and the second current are configured to charge the output capacitor to generate the output voltage;
wherein a direction of the first current is the same as a direction of the second current.

7. The power conversion circuit as claimed in claim 6, wherein the voltage detection signal is close to the threshold voltage;
wherein when the voltage detection signal is close to half of the input voltage, magnitude of the first current is close to magnitude of the second current, thereby reducing a ripple of the output voltage.

8. The power conversion circuit as defined in claim 1, wherein the control circuit comprises:
a valley-voltage detection circuit, configured to detect a voltage across the low-side transistor at a relatively low point to generate a valley signal;
wherein the control circuit turns on the low-side transistor based on the valley signal, so as to reduce switching power loss of the low-side transistor.

9. The power conversion circuit as defined in claim 1, wherein when the low-side transistor is turned off and a dead time has passed, the high-side transistor is turned on to achieve zero voltage switching.

10. The power conversion circuit as defined in claim 1, wherein when the high-side transistor is turned off and a dead time has passed, the low-side transistor is turned on to achieve zero voltage switching.

11. The power conversion circuit as defined in claim 1, wherein the detection circuit comprises a resistor and a capacitor;
wherein the resistor and the capacitor are connected in series between the resonant node and the ground;
wherein a voltage across the resistor is the current detection signal.

12. The power conversion circuit as defined in claim 11, wherein the detection circuit further comprises:
an integrator, integrating the current detection signal to generate the voltage detection signal.

13. The power conversion circuit as defined in claim 1, wherein the detection circuit comprises:
a detection resistor, coupled between the resonant capacitor and the ground;
wherein a voltage across the detection resistor is the current detection signal.

14. The power conversion circuit as defined in claim 1, wherein the detection circuit comprises:
a capacitance voltage-dividing circuit, coupled to both terminals of the resonant capacitor;
wherein the capacitance voltage-dividing circuit is configured to divide a voltage across the resonant capacitor to generate the voltage detection signal.

15. A control method adapted to control a power conversion circuit, wherein the power conversion circuit comprises a resonant capacitor between a resonant node and a ground, a transformer comprising a primary coil and a secondary coil, a high-side transistor providing an input voltage to a switch node, a low-side transistor coupling the switch node to the ground, and a rectification circuit converting energy of the secondary coil into an output voltage, wherein the primary coil is coupled between the switch node and the resonant node, wherein the control method comprises the following steps:
comparing the output voltage with a reference voltage to generate a compensation signal;
generating a current detection signal based on a current flowing through the resonant capacitor;
generating a voltage detection signal related to a voltage across the resonant capacitor; and
driving the high-side transistor and the low-side transistor based on the current detection signal, the voltage detection signal, the compensation signal, and the input voltage;
wherein when the high-side transistor is turned on and the current detection signal exceeds the compensation signal, turning off the high-side transistor;
wherein when the voltage detection signal does not exceed a threshold, turning off the low-side transistor.

16. The control method as claimed in claim 15, wherein the control method further comprises the following steps:
detecting a voltage across the low-side transistor; and
when the voltage across the low-side transistor is a valley voltage, turning on the low-side transistor, thereby reducing switching power loss of the low-side transistor.

17. The control method as claimed in claim 15, wherein when the low-side transistor is turned off and a dead time has passed, the high-side transistor is turned on to achieve zero voltage switching.

18. The control method as claimed in claim 15, wherein when the high-side transistor is turned off and a dead time has passed, the low-side transistor is turned on to achieve zero voltage switching.

19. The control method as claimed in claim 15, wherein the threshold voltage is determined based on half of the input voltage.

20. The control method as claimed in claim 19, wherein the rectification circuit comprises an output capacitor, a first rectification unit generating a first current, and a second rectification unit generating a second current;
wherein the first current and the second current charge the output capacitor to generate the output voltage;
wherein the voltage detection signal is close to the threshold voltage;
wherein when the voltage detection signal is close to half of the input voltage, magnitude of the first current is close to magnitude of the second current, so as to reduce a ripple of the output voltage.
